(19) United States
(12) Patent Application Publication
(10) Pub. No.: US 2013/0018715 A1
(43) Pub. Date: Jan. 17, 2013

(54) FACILITATING MOBILE DEVICE PAYMENTS USING PRODUCT CODE SCANNING TO ENABLE SELF CHECKOUT

(71) Applicants: Tiger T G Zhou, Tiburon, CA (US); Dylan T X Zhou, San Gabriel, CA (US); Andrew H B Zhou, Tiburon, CA (US)

(72) Inventors: Tiger T G Zhou, Tiburon, CA (US); Dylan T X Zhou, San Gabriel, CA (US); Andrew H B Zhou, Tiburon, CA (US)

(21) Appl. No.: 13/623,944

(22) Filed: Sep. 21, 2012

Related U.S. Application Data
(63) Continuation-in-part of application No. 13/185,491, filed on Jul. 18, 2011.

(51) Int. Cl. G06Q 30/06; G06Q 30/02

(52) U.S. Cl. 705/14.23; 705/26.1; 705/26.9; 705/26.8; 705/26.7

(57) ABSTRACT

Provided are computer implemented methods and systems for facilitating mobile device payments using product scanning and wireless communication functionality of mobile devices. Using a mobile device, a customer may read product codes and receive product information, which may include a product price, a manufacture date, a manufacturing country, a quantity of products. When reading the product codes, the customer may be also provided with promotional offers and advertising material from a merchant, a mobile payment service provider, or a third party. Upon reading the product codes, the reading may be stored in a list on the mobile device. The user may further send a request to calculate a total price of the products read by the mobile device. The total price may be encoded in a code scannable by a merchant scanning device.

### CROSS-REFERENCE TO RELATED APPLICATIONS

This application is a continuation-in-part of U.S. patent application Ser. No. 13/185,491, entitled “FACILITATING MOBILE DEVICE PAYMENTS USING PRODUCT CODE SCANNING,” filed on Jul. 18, 2011, which is incorporated herein by reference in its entirety.

### FIELD

This application relates generally to purchasing product items using mobile devices in various retail environments and, more specifically, to computer implemented methods and systems for facilitating mobile device payments using product scanning and wireless communication functionality of these mobile devices.

### BACKGROUND

When customers buy product items from various merchants in these merchants' retails environments, such as retail outlets, shopping centers, stores, etc., only a handful of payment methods available to the customers. Typical examples include credit cards, debit cards, gift cards, checks, and cash. Each one of these payment methods has some drawbacks from cost and/or convenience perspectives. For example, credit cards bear substantial processing fees, while debit cards require availability of funds and sometimes involve surcharges as well. Checks and cash transactions are slow and require additional processing and/or handling. All these drawbacks interfere with retail transactions and add some level of dissatisfaction.

At the same time, a customer typically visits the same group of stores repeatedly, and these payment transaction fees tend to accumulate. While some stores try to issue their own credit-like account systems and employ banks to help them in this endeavor (e.g., Sears—Chase VISA), many stores are simply too small to build and operate systems similar to those provided by the major credit card companies and/or banks. Furthermore, a typical customer may repeatedly visit multiple retail outlets. Continuous usage of multiple cards (or other security/transactional devices) each one being specific to only one of these outlets may be difficult, if note unreasonable. For example, a typical customer may use a few gas stations (e.g., depending on his location), a few grocery stores (e.g., depending on preferences), a few electronic stores (e.g., depending on current sales and promotions). Complexities introduced by store specific account systems may quickly offset any costs savings or cause inconvenience associated with traditional methods of payments and may make the overall experience even worse.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer implemented methods and systems for facilitating mobile device payments using product scanning and wireless communication functionality of mobile devices. In general, these methods and systems are designed to improve an overall purchasing and selling process.

According to the methods and systems disclosed herein, a user may send a request via his mobile device to read product codes. Upon reading the product codes, the user may receive product information which may include a product price, a manufacture date, a manufacturing country, and a quantity of goods. Each new reading may be stored in a list. Furthermore, the user may create own product lists to store certain products. Once the product codes have been read, the user may further transmit data on all the products read by his mobile device to a payment processing system and send a request to calculate a total price of the products. The total price may be calculated automatically and may be encoded in a code scannable by a merchant scanning device. To transfer payment for the products, payment authorization may be transmitted to a payment processing system. Furthermore, the user may pay with digital mobile money received for cash provided by the user to a mobile payment service provider. Additionally, the user may also receive compensation based on criteria determined by a merchant.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating an example of the overall system, in accordance with certain embodiments.

FIG. 2 is a block diagram showing various modules of the payment processing system, in accordance with certain embodiments.

FIG. 3A is a flow chart illustrating a method for purchasing a product item in a retail environment using a mobile device, in accordance with certain embodiments.

FIG. 3B is a flow chart illustrating a method for purchasing a product item using a payment server, in accordance with certain embodiments.

FIG. 4A illustrates a computer system within which a set of instructions for causing the machine to perform any one or more of the methodologies discussed herein is executed, in accordance with certain embodiments.

FIG. 4B illustrates an example of a mobile device, in accordance with certain embodiments.

FIG. 5 illustrates another embodiment of the method for purchasing a product item in a retail environment using a mobile device, in accordance with certain embodiments.

FIG. 6 is a block diagram showing another embodiment of a payment processing system, in accordance with certain embodiments.

### DETAILED DESCRIPTION

Various computer implemented methods and systems for facilitating mobile device payments using product scanning and wireless communication functionalities of mobile devices are described herein. Recent proliferation of mobile devices (e.g., cell phones/smart phones and other similar devices) that are capable of scanning and processing various printed codes (e.g., barcodes) as well as process and communicate data contained in these codes allows implementing these novel methods and systems. Most customers shopping in today's retail environments carry such mobiles devices. Furthermore, costs of many such devices dropped substantially such that merchants may easily lend one or more devices for use by customers while they shop in the retail environments of these merchants.

Product codes are typically provided as barcodes, such as linear barcodes and two dimensional barcodes, as well as human readable alphanumeric codes. For example, the Universal Product Code (UPC) or European Article Number (EAN) may be used. UPC is a barcode symbology widely used in North America and other countries for tracking trade items in stores. Its most common form, the UPC-A, consists of 12 numerical digits, which are uniquely assigned to each individual trade/product item. Each UPC-A barcode consists of a scannable strip of black bars and white spaces, above a sequence of 12 numerical digits. No letters, characters, or other content of any kind may appear on a standard UPC-A barcode. The digits and bars maintain a one-to-one correspondence. In other words, there is only one way to represent each 12-digit number visually, and there is only one way to represent each visual barcode numerically. EAN is another example developed as a superset of UPC and adding an extra digit to the beginning of every UPC number. An EAN-13 barcode, a 13 EAN barcoding standard, also indicates the country in which the company that sells the product is based using leading digits. EAN and UPC barcodes are currently the only barcodes allowed for scanning trade/product items at the point of sale. However, other codes may be available in the future and within the scope of this document.

One having ordinary skills in the art would understand that the term “scanning” is not limited to printed codes having particular formats but may be used for codes encoded electronically and using various other means. For example, product codes may be in a form of the recently developed Electronic Product Code (EPC) is designed as a universal identifier that provides a unique identity for every physical object (not just a trade item category) anywhere in the world, for all time. It should be noted that EPCs are not exclusively used with RFID data carriers. They may be constructed based on reading of optical data carriers, such as linear bar codes and two-dimensional bar codes, such as Data Matrix symbols. For purposes of this document, all optical data carriers are referred herein as “barcodes.”

Scanning a barcodes may involve capturing an image of the barcode using a simple imaging device installed on a mobile device, such as a digital camera. The image may be then processed on the mobile device to retrieve corresponding product information or sent to the server for further processing. The local processing may be performed using various software installed on the mobile device. In certain embodiments, a mobile device may contain a local database to match the retrieved product information with additional information about this product. However, because of variable nature of this additional information (e.g., pricing, product description), a mobile device then typically transmits the retrieved product information to the server and then receives some additional information from the server.

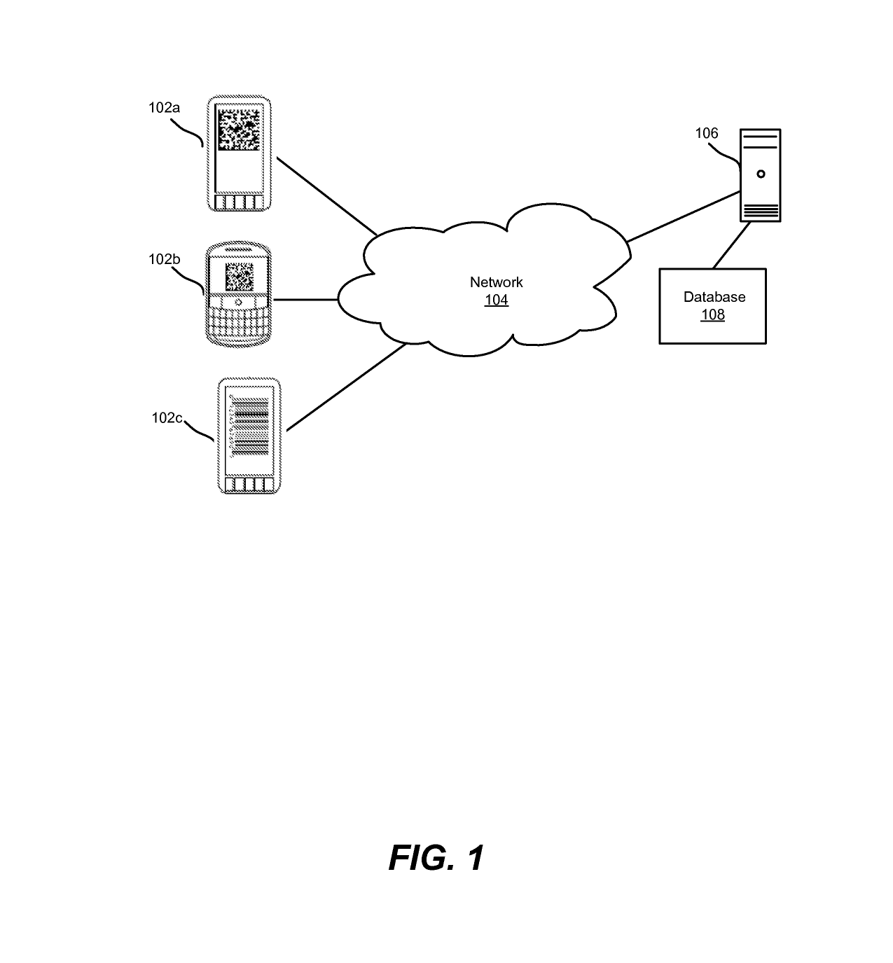

The methods described herein may be performed by any mobile devices with wireless communication capabilities. In addition to being capable of transmitting voice-based signals, many modern cell phones also have internet connectivity using cellular networks (e.g., 3G, 4G) as well as Wi-Fi and other types of networks. Some additional examples of such networks are described below with reference to FIG. 1. Wireless communication may be used to transmit retrieved product information to a payment server, receive replies, and transmit authorizations. Overall, various data may be exchanged between the mobile devices and the payment server as well as other servers during operations of the method.

The methods and systems described herein may be used for mobile applications. The mobile applications may be provided by a merchant, a third party, or a mobile payment service provider.

Referring now to figures, FIG. 1 is a block diagram illustrating an example of the overall system, in accordance with certain embodiments. As shown, multiple mobile devices 102a, 102b, 102c may communicate with a payment server 106 via a network 104. The network 104 may be also used for communicating with other servers (e.g., to retrieve additional product information) and retail systems e.g., to inform the checkout counters about completed purchase). The network 104 may take any suitable form, such as a wide area network or Internet and/or one or more local area networks (LAN's). The network 104 may include any suitable number and type of devices, e.g., routers and switches, for forwarding commands, content, and/or web object requests from each client to the online community application and responses back to the clients.

The methods describe herein may also be practiced in a wide variety of network environments (represented by network 104) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be effected or employed at different locations.

During communication between the payment server 106 and one or more mobile devices 102a, 102b, and 102c, the payment server 106 may retrieve various payment account information and/or product information. This type of information may be stored in one or more databases 108. Different databases may have different access levels. For example, product database may be open and does not require login to access certain contents of this database. To the contrary, payment account database may have secure access based on login information or other security features verification.

The mobile devices 102a, 102b, 102c are equipped with scanners for scanning product codes on product items that are provided in retail environments. One example of such scanners is a camera capturing images of the product code. Another example is an actual barcode scanner. Yet another example is an RFID scanners.

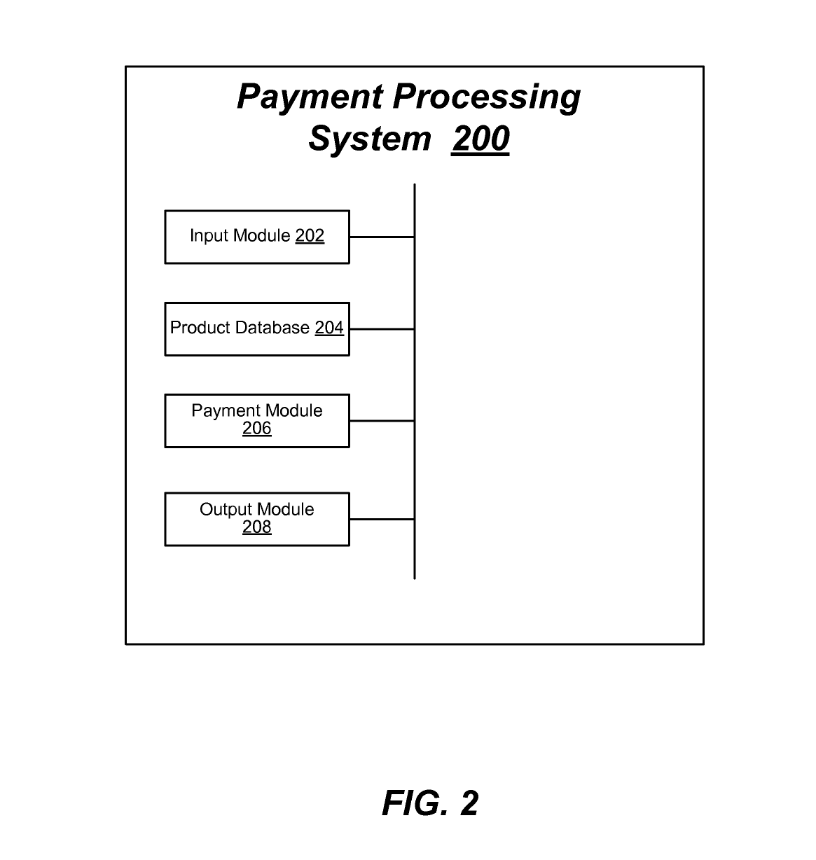

FIG. 2 is a block diagram showing various modules of payment processing system 200, in accordance with certain embodiments. In certain embodiments, the payment processing system 200 includes an input module 202. The input module 202 may be used for communicating via the network with one or more mobile devices, e.g., for receiving product information from the one or more mobile devices. The input module 202 may be also used for receiving login information from the mobile devices and/or account information.

In the same or other embodiments, the payment processing system 200 includes a product database 204. The product database 204 may be used for storing product related data, e.g., product pricing information, product discount information, product description information, and complementary product information. As stated above, product related data may correspond to each individual product items based on the product information.

In certain embodiments, the payment processing system 200 includes a payment module 206 for receiving payment authorization from the one or more mobile devices and transferring funds between one or more accounts. The payment module 206 or other modules may have access to user's payment account, which may include credit information, debit information, discount information, and loyalty program information. The payment processing system 200 may include also an output module 208 for sending product related data and payment information to the mobile devices.

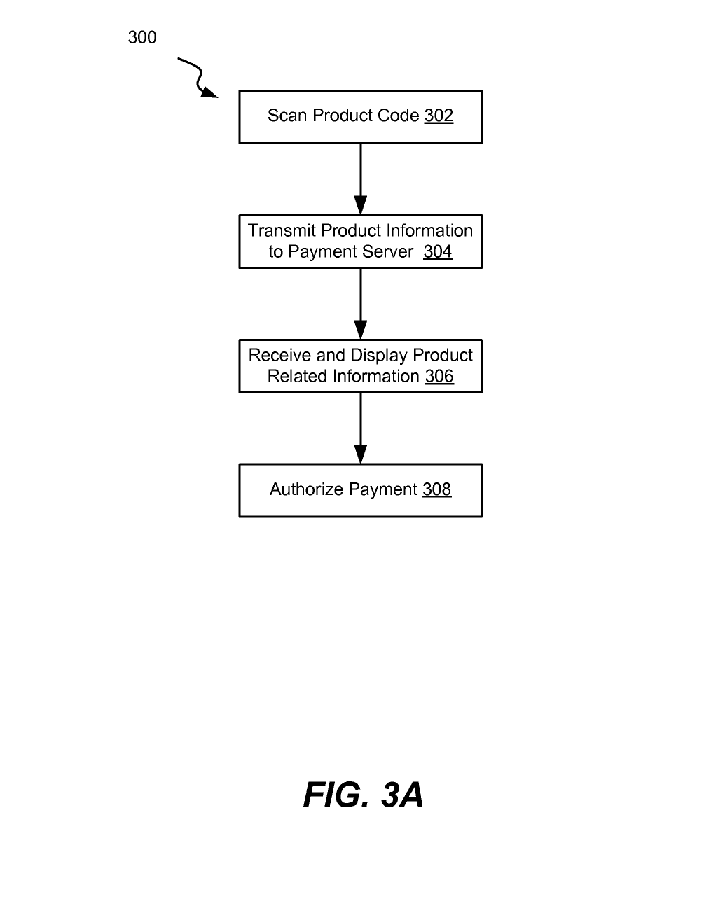

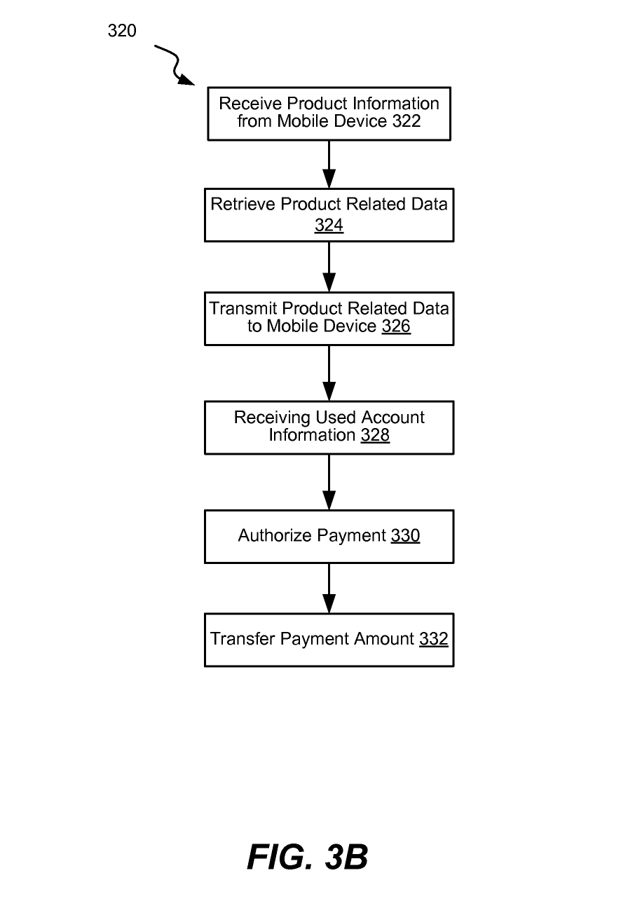

FIG. 3A is a flow chart illustrating a method 300 for purchasing for a product item in a retail environment using a mobile device, in accordance with certain embodiments. The method 300 may start with scanning a product code in operation 302. For example, a mobile device may be used to capture an image of the product code. This image is then processed by the mobile device to retrieve product information (e.g., UPC or EAN code) encoded in the product code. In certain embodiments, an actual image of the product code is considered being product information and it is transmitted to the payment server or some other server for further processing. In some instances, machine readable code cannot be scanned. For example, product code image provided of the product item is damaged. In these instanced, a user may enter an alphanumeric code on the user interface of the mobile device. This alphanumeric code is product information transmitted to the payment server or some other server in later operations.

In certain embodiments, the method 300 involves registering mobile device with the payment server or some other components of the payment system. For example, user account information may be transmitted to the payment server. The user account information may correspond to a specific payment account at the payment server. Each used may have a dedicated payment account. User account information may involve a combination of username and password or some other security features. In certain embodiments, registering the mobile device with the payment server is performed prior to transmitting the product information to the payment server at operation 304.

The method 300 may involve transmitting the product information to the payment server in operation 304. Some Examples of product information include alphanumeric representation corresponding to UPC, EAN, EPC, and other types of codes. This product information may be then correlated to the product related data by the payment server further describe below with reference to FIG. 3B.

The method 300 may involve receiving and displaying product related information in operation 306. Some examples of product related information include product pricing information, product discount information, product description information, and complementary product information.

Finally, the method 300 also involves authorizing payment in operation 308. The authorization is transmitted to the payment server and may be used for transferring funds between accounts and/or other purposes (e.g., authorizing credit).

FIG. 3B is a flow chart illustrating a method for purchasing a product item using a payment server, in accordance with certain embodiments. It should be noted that process 300 described above with reference to FIG. 3A and a process 320 described herein are performed in parallel in different parts of the network. Specifically, operations of the process 300 are performed by one or more mobile devices, while operations of the process 320 are performed by one or more servers.

The process 320 involves receiving product information from a mobile device in operation 322. Examples of product information are described above. Overall, operation 322 is a server-side operation corresponding to operation 306 described above with reference to FIG. 3A. Based on product information, a payment server or some other server may retrieve product related data in operation 324, which is then transmitted to the mobile device in operation 326. Product related data may be added into the product database. For example, when a merchant adds another product item (e.g., an SKU) to the retail environment, the corresponding product related information may be added to the product database. Various example of the product related data are described above. Furthermore, process 320 may involve receiving a used account information in operation 328, which s is a server-side operation corresponding to the operation 304 described above with reference to FIG. 3A.

The process 320 then proceeds with receiving payment authorization in operation 330. The authorization is sent by the mobile device and may be used a secured protocol for transmission. Based on this authorization, process 320 may then involve transfer of the payment amount in operation 332 from one account to another. In certain specific embodiments, the transfer involves crediting payment amount.

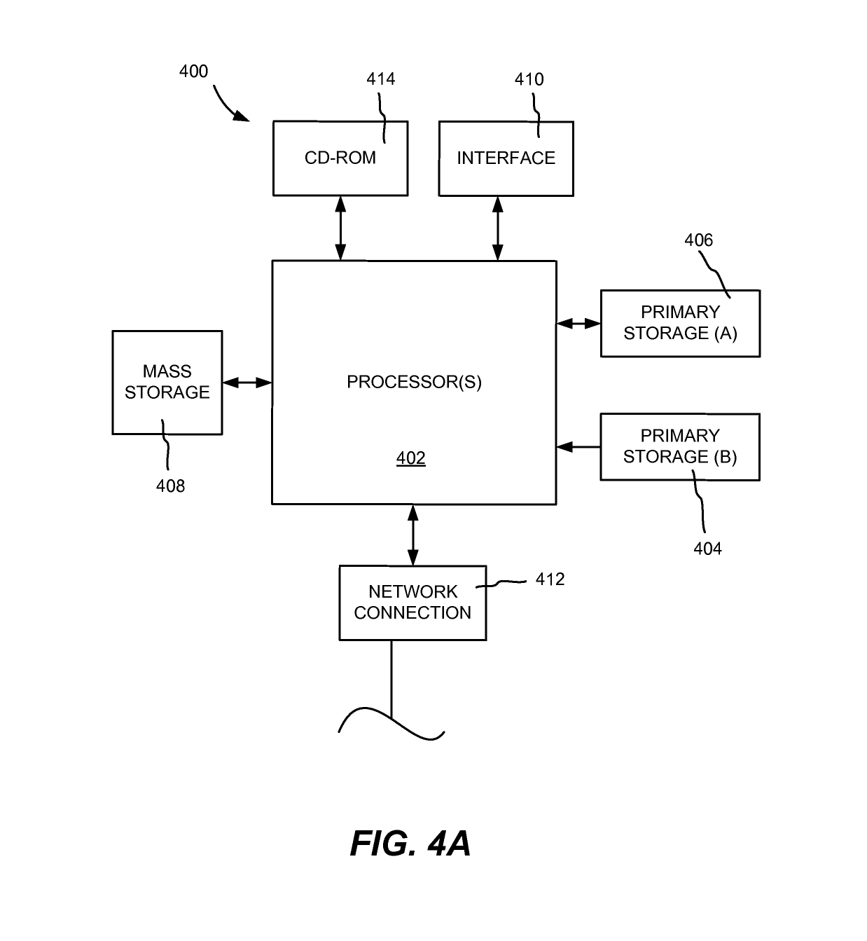

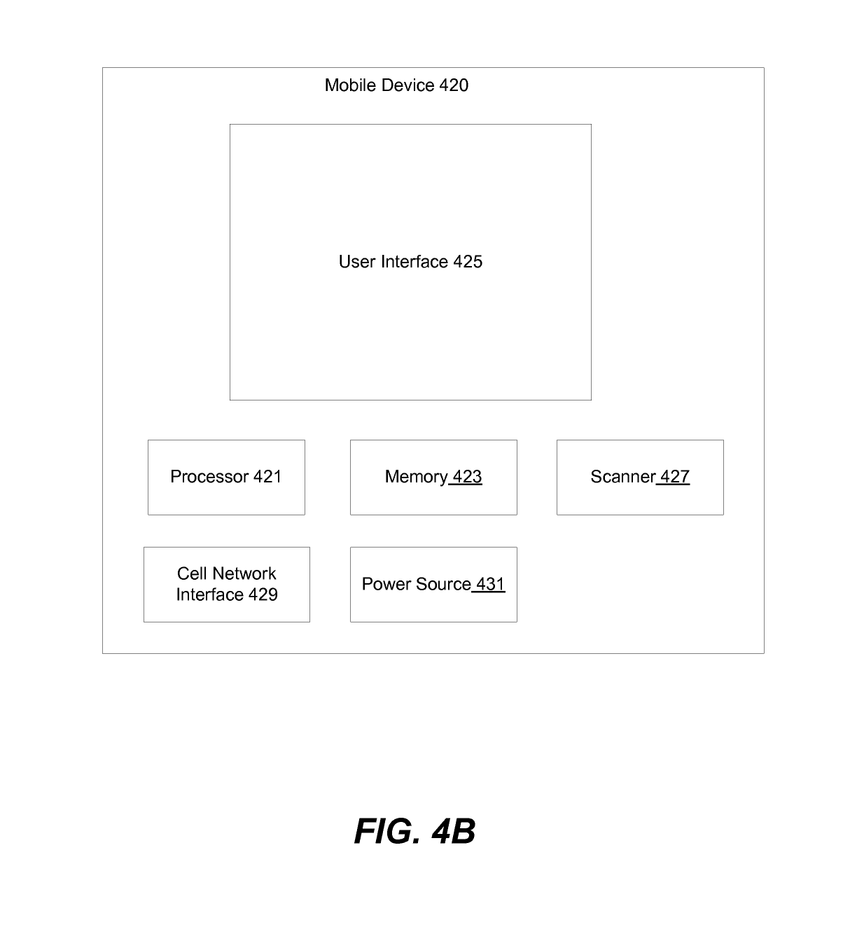

FIG. 4A illustrates a computer system within which a set of instructions for causing the machine to perform any one or more of the methodologies discussed herein is executed, in accordance with certain embodiments. The computer system 400 includes any number of processors 402 (also referred to as central processing units, or CPUs) that are coupled to storage devices including a primary storage 406 (typically a random access memory, or RAM), a primary storage 404 (typically a read only memory, or ROM). The CPU 402 may be of various types including microcontrollers and microprocessors such as programmable devices (e.g., CPLDs and FPGAs) and unprogrammable devices such as gate array ASICs or general purpose microprocessors. The primary storage 404 may act to transfer data and instructions uni-directionally to the CPU 402 and the primary storage 406 is used typically to transfer data and instructions in a bi-directional manner. Both of these primary storage devices may include any suitable computer-readable media such as those described above. A mass storage device 408 is also coupled bi-directionally to the CPU 402 and provides additional data storage capacity and may include any of the computer-readable media described above. The mass storage device 408 may be used to store programs, data and the like and is typically a secondary storage medium such as a hard disk. It will be appreciated that the information retained within the mass storage device 408, may, in appropriate cases, be incorporated in standard fashion as part of the primary storage 406 as virtual memory. A specific mass storage device such as a CD-ROM 414 may also pass data uni-directionally to the CPU 402.

The CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPU 402 optionally may be coupled to an external device such as a database or a computer or telecommunications network using an external network connection 412. Being connected via a network, the CPU 402 may receive information from the network, or might output information to the network in the course of performing the operations described herein.

The example embodiments described herein may be implemented in an operating environment including software installed on a computer, in hardware, or in a combination of software and hardware.

FIG. 4B illustrates a particular example of a mobile device 420. The mobile device 420 includes a processor 421, a memory 423, a user interface 425, a cellular network interface 429, a scanner 427, and a power source 431. The scanner 427 may retrieve product information from product codes. Some examples of scanners include digital cameras, bar code readers, and RFID readers. The processor 421 may be specifically configured to provide render product information from the product codes. The user interface 425, such as an LCD screen, is configured to display different product information, e.g., retrieve from the product code and/or received from the payment server. The memory 423 may be configured to store various security features associate with the transaction. Furthermore, advanced processing, communicating, scanning and displaying capabilities of the mobile devices and more frequent use of these capabilities may need substantial power outputs provided by the power source 431.

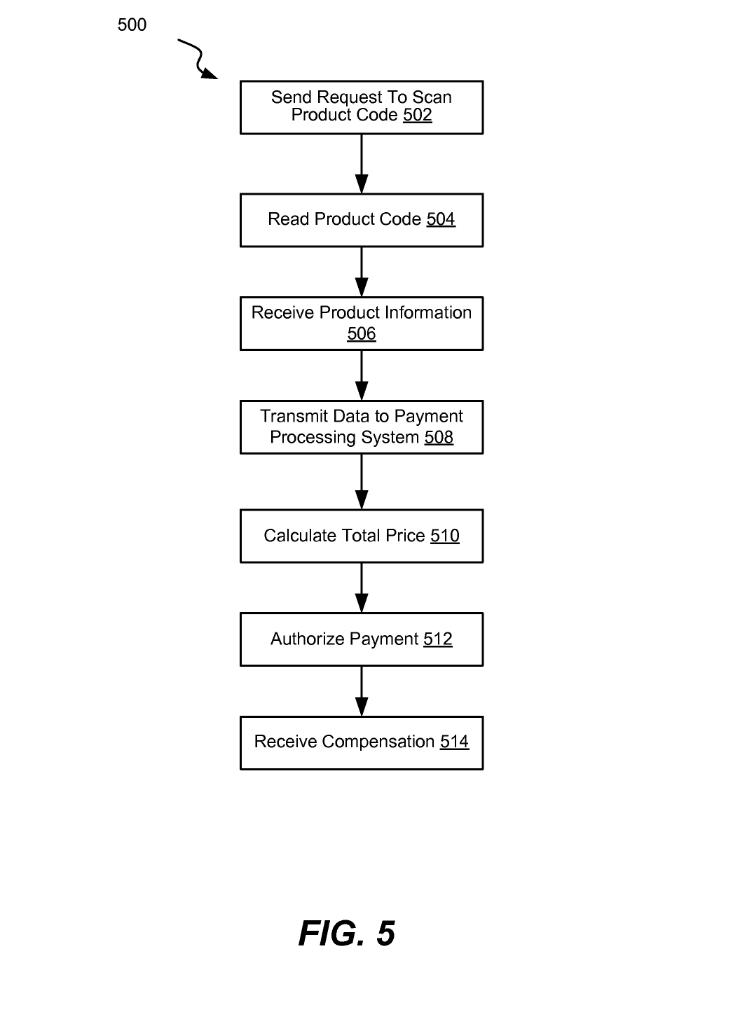

FIG. 5 illustrates another embodiment of the method for purchasing a product item in a retail environment using a mobile device, in accordance with certain embodiments. Before performing a method 500, a user may connect to a wireless network of a merchant. The merchant may include any store or outdoor shopping place. In certain embodiments, the user may also connect to his wireless network.

As shown in FIG. 5, a method 500 may commence at sending a request to read a product code at operation 502. Upon sending a request, the user may read the product code at operation 504. The reading may include scanning the product code by a mobile device and decoding the product code to receive product information at operation 506. The product information may include a product price, a manufacture date, a manufacturing country, or a quantity of products. Prior to the reading, the method 500 may also include determining an aisle location of products. Each reading may be stored in a list of read products on the mobile device. The user may select a barcode of a product to be purchased and place it in a virtual cart. In addition, the user may create own product lists. Furthermore, a list of other recommended products may be displayed on the screen of the mobile device for further purchase. In certain embodiments, the user may place a remote order for home delivery of unavailable products. The remote order may be placed in any corresponding store.

In certain embodiments, during the reading, the user may receive digital coupons and offers and decide whether to make an immediate purchase or to store the coupons on the mobile device to purchase next time. In certain embodiments, during the reading, the user may also receive promotional offers and advertising from a merchant, a third party, or a mobile payment service provider and may contain barcoded information.

Upon receiving the product information at the operation 506, the method 500 may further proceed with transmitting data on all products read by the mobile device to a payment processing system at operation 508. The method 500 may further include automatically calculating a total price of products upon user request at operation 510. In certain embodiments, the method 500 may also include receiving a request, from the customer, to check a total amount and price of the reading. For example, the user may check a total price, an amount, and a type of goods available in his virtual cart. In certain embodiments, the user may also selectively remove items of the reading.

The method 500 may further proceed with authorizing payment and transmitting payment authorization to the payment processing system at operation 512 for transferring funds to a merchant account. In certain embodiments, the user may pay with digital mobile money received for cash provided by the user to a mobile payment service provider. The digital mobile money may be customer payment information encoded in a barcode scannable by a merchant scanning device.

In certain embodiments, the user may pay with a restored payment card by sending a request to make payment via an interface of the mobile device. The payment card may include any credit or debit card.

In certain embodiments, the user may swipe his payment card to complete a purchase.

In certain embodiments, the method 500 may include receiving compensation at operation 514. The compensation may include cashback, a discount, and a gift card and may be determined by a merchant. In certain embodiments, the user may receive a digital receipt containing information on cashback and discount. The digital receipt may be sent by email. In certain embodiments, the user may send a request via the interface of the mobile device to check a total amount of money saved.

In certain embodiments, in case of problems with any user-related operations described above, the method 500 may further include receiving a reminder for the user to send a request for help. The reminder may be automatically displayed on a screen of the mobile device.

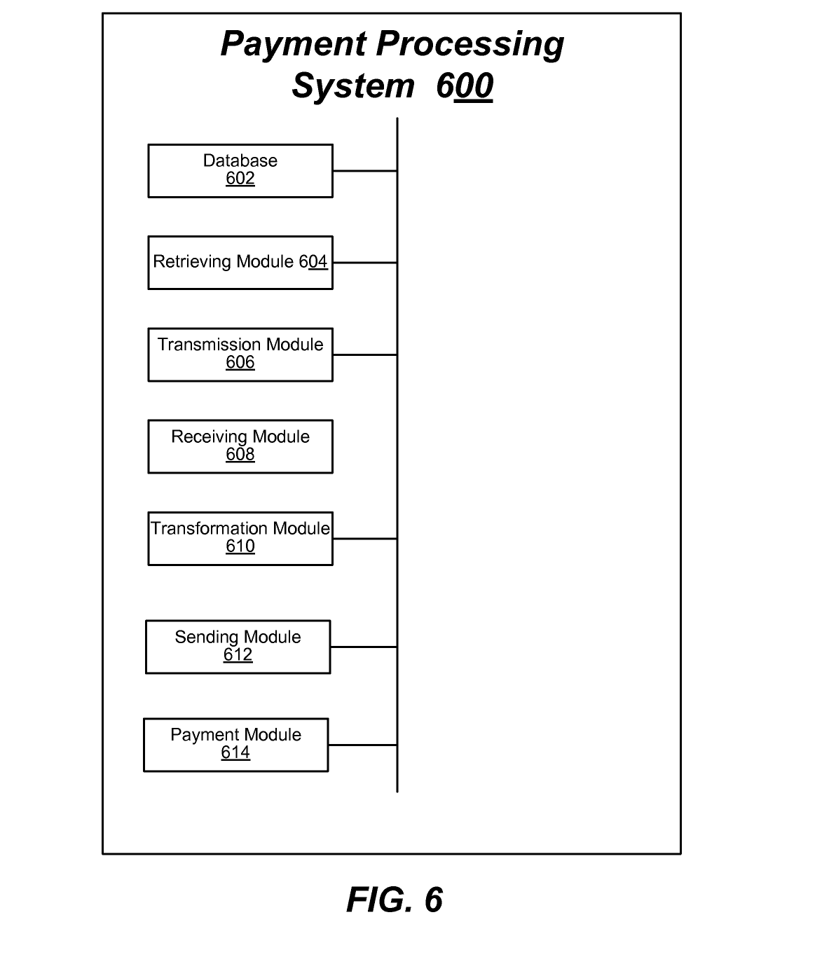

FIG. 6 is a block diagram showing another embodiment of a payment processing system, in accordance with certain embodiments. A payment processing system 600 may include a database 602 for storing product information and customer related data and a retrieving module 604 for retrieving the product information from the database 602. In certain embodiments, the payment processing system 600 may further include a transmission module 606 for transmitting the product information to the mobile device and a receiving module 608 for receiving data on products read by the mobile device. Furthermore, the payment processing system 600 may include a transformation module 610 for automatically calculating and encoding a total price of the products. In certain embodiments, the total price of the products may be scanned by a merchant scanning device to receive payment for the products. The payment processing system 600 may also include a sending module 612 for sending digital receipts to a customer email and a payment module 614 for receiving payment authorization and funds from a customer account, transferring cashback and providing a discount to a customer. In addition, the customer account may be automatically updated based on a payment amount transferred.

Thus, various systems and methods for purchasing for a product item in a retail environment using a mobile device and a payment server have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method for purchasing a product item in a retail environment using a mobile device, the method comprising:
using a mobile device, sending a request to read one or more product codes;
reading the one or more product codes corresponding to one or more products;
based on the reading, receiving product information;
transmitting data on the reading to a payment processing system;
receiving a request, from a customer, to calculate a total price of the reading;
based on the request, calculating the total price of the reading,
authorizing payment and transmitting authorization to the payment processing system; and
selectively receiving a compensation based on predetermined criteria.

2. The computer-implemented method of claim 1, wherein the reading is stored in a list of read products on the mobile device.

3. The computer-implemented method of claim 1, further comprising receiving a request, from the customer, to pay for the one or more products with a restored payment card.

4. The computer-implemented method of claim 1, wherein the total price is encoded in a code, the total price being scannable by a merchant scanning device to transfer payment for the one or more products.

5. The computer-implemented method of claim 1, further comprising:
receiving a request from a customer to determine an aisle location of the one or more products; and
determining the aisle location of the one or more products.

6. The computer-implemented method of claim 1, wherein a customer creates one or more product lists.

7. The computer-implemented method of claim 1, further comprising connecting to a wireless network of a merchant.

8. The computer-implemented method of claim 7, wherein the merchant includes a store, an outdoor shopping place.

9. The computer-implemented method of claim 1, further comprising connecting to a wireless network of the customer.

10. The computer-implemented method of claim 1, wherein the product information includes one or more of the following: a product price, a manufacture date, a manufacturing country, a quantity of products.

11. The computer-implemented method of claim 1, further comprising displaying a list of other recommended products on a screen of the mobile device.

12. The computer-implemented method of claim 1, further comprising receiving digital coupons and offers to make a purchase.

13. The computer-implemented method of claim 12, wherein the digital coupons are stored on the mobile device for further usage.

14. The computer-implemented method of claim 1, further comprising receiving promotional offers and advertising.

15. The computer-implemented method of claim 14, wherein the promotional offers and advertising contain barcoded information.

16. The computer-implemented method of claim 14, wherein the promotional offers and advertising are received from one or more of the following: a merchant, a mobile payment service provider, a third party.

17. The computer-implemented method of claim 1, further comprising receiving digital mobile money for cash provided by a customer.

18. The computer-implemented method of claim 17, wherein the digital mobile money is customer payment information encoded in a barcode, the barcode being scannable by a merchant scanning device.

19. The computer-implemented method of claim 1, wherein the compensation includes one or more of the following: cashback, a discount, and a gift card.

20. The computer-implemented method of claim 1, wherein the customer receives a digital receipt by email, the digital receipt containing detailed information on cashback and discount.

21. The computer-implemented method of claim 1, further comprising receiving a request, from the customer, to check a total amount and price of the reading.

22. The computer-implemented method of claim 21, further comprising selectively removing one or more items of the reading.

23. The computer-implemented method of claim 1, further comprising sending a request to check a total amount of money saved.

24. The computer-implemented method of claim 1, further comprising placing a remote order for home delivery of one or more unavailable products.

25. The computer-implemented method of claim 1, further comprising receiving a reminder for the customer to send a request for help, the reminder being displayed on a screen of the mobile device.

26. A computer-implemented system for purchasing a product item in a retail environment using a mobile device, the system comprising a processor configured to:
using a mobile device, read one or more product codes corresponding to one or more products;
based on the reading, receive product information;
transmit data on the reading to a payment processing system;
receive a request, from a customer, to calculate a total price of the reading;
based on the request, calculate the total price of the reading, the total price being encoded in a code scannable by a merchant scanning device;
authorize payment and transmit authorization to the payment processing system; and
selectively receive a compensation based on predetermined criteria.

27. The computer-implemented system of claim 26, wherein the reading is stored in a list of read products on the mobile device.

28. The computer-implemented system of claim 26, wherein the merchant includes a store, an outdoor shopping place.

29. The computer-implemented system of claim 26, wherein the processor is further configured to receive a request from a customer to determine an aisle location of the one or more products.

30. The computer-implemented system of claim 26, wherein the processor is further configured to connect to a wireless network of a merchant.

31. The computer-implemented system of claim 26, wherein the processor is further configured to connect to a wireless network of a customer.

32. The computer-implemented system of claim 26, wherein the product information includes one or more of the following: a product price, a manufacture date, a manufacturing country, a quantity of products.

33. The computer-implemented system of claim 26, wherein the processor is further configured to display a list of other recommended products on a screen of the mobile device.

34. The computer-implemented system of claim 26 wherein the processor is further configured to receive digital coupons and offers to make a purchase.

35. The computer-implemented system of claim 34, wherein the digital coupons are stored on the mobile device for further usage.

36. The computer-implemented system of claim 26, wherein the processor is further configured to receive promotional offers and advertising.

37. The computer-implemented system of claim 36, wherein the promotional offers and advertising contain barcoded information.

38. The computer-implemented system of claim 36, wherein the promotional offers and advertising are received from one or more of the following: a merchant, a mobile payment service provider, a third party.

39. The computer-implemented system of claim 26, wherein the processor is further configured to receive digital mobile money for cash provided by a customer.

40. The computer-implemented system of claim 39, wherein the digital mobile money is customer payment information encoded in a barcode, the barcode being scannable by a merchant.

41. A payment processing system for purchasing a product item in a retail environment using a mobile device, the system comprising:
a database for storing product information and customer related data;
a retrieving module for retrieving the product information from the database;
a transmission module for transmitting the product information to a mobile device;
a receiving module for receiving data on one or more products read by the mobile device;
a transformation module for automatically calculating and encoding a total price of one or more products;
a sending module for sending digital receipts to a customer email; and
a payment module for receiving payment authorization and funds from a customer account, transferring cashback and providing a discount to a customer.

42. The merchant payment system of claim 41, wherein the customer account is automatically updated based on the payment amount transferred.
